(19) United States
(12) Patent Application Publication
(10) Pub. No.: US 2020/0032425 A1
(43) Pub. Date: Jan. 30, 2020

(54) CLEANING DEVICE FOR CLEANING A ROTOR PLATE OF A SPINNING ROTOR, COMPRISING A CLEANING HEAD

(71) Applicant: Maschinenfabrik Rieter AG, Winterthur (CH)

(72) Inventors: Harald Widner, Ingolstadt (DE); Sebastian Fritz, Dietfurt (DE)

(21) Appl. No.: 16/523,652

(22) Filed: Jul. 26, 2019

(30) Foreign Application Priority Data
Jul. 27, 2018 (DE) 10 2018 118 269.4

(51) Int. Cl. D01H 4/24; D01H 4/50; D01H 4/12; B08B 13/00

(52) U.S. Cl. CPC D01H 4/24; B08B 13/00; D01H 4/12; D01H 4/50

(57) ABSTRACT

A cleaning device (1) for cleaning a rotor plate (2) of a spinning rotor (3) comprises a receptacle (6), a cleaning head (4) mounted on the receptacle (6), which can be advanced toward the spinning rotor (3) for cleaning and which includes at least one cleaning element (5, 5a, 5b), and comprising a brake device (11) for decelerating and/or holding the spinning rotor (3) once the cleaning head (4) has been advanced. The cleaning head (4) comprises an at least partially cylindrical receiving area (7) for the spinning rotor (3), which defines an axial direction (AR) and a radial direction (RR) of the cleaning head (4). The brake device (11) contains multiple, in particular two, brake elements (12), which are mounted on the cleaning head (4) in such a way that they are movable from a neutral position into a braking position, and each of the multiple brake elements (12) is movable with the aid of its own drive (13).

The present invention relates to a cleaning device for cleaning a rotor plate of a spinning rotor, comprising a receptacle, a cleaning head mounted on the receptacle, which can be advanced toward the spinning rotor for cleaning and which includes at least one cleaning element, and comprising a brake device for decelerating and/or holding the spinning rotor once the cleaning head has been advanced. The cleaning head comprises, in this case, an at least partially cylindrical receiving area for the spinning rotor, which defines an axial direction and a radial direction of the cleaning head.

DE 33 13 926 A1 describes a cleaning device for a spinning rotor, in which a cleaning brush, as a cleaning element, is introduced into the spinning rotor in order to clean the fiber collecting groove of the spinning rotor. The cleaning device is provided with a bell-shaped brake, which comprises a brake pad on its edge. The cleaning head of the cleaning unit can be advanced toward the spinning rotor, wherein the bell-shaped brake rests against the outer surface of the spinning rotor and, as a result, decelerates the spinning rotor. Either the cleaning brush or the spinning rotor, or both, if necessary, can be driven in order to clean the spinning rotor. If the cleaning head, including the bell-shaped brake and the cleaning brush, has an offset with respect to the rotor, insufficient cleaning can occur.

DE 103 14 936 A1 describes a cleaning head, in the case of which a scraper is introduced into the interior of the spinning rotor and is set into a rotary motion. Contact elements are provided on the cleaning head, which rest against an outer surface of the spinning rotor, for the axial positioning of the cleaning head with respect to the spinning rotor. The contact surfaces of the contact elements can also be slanted in order to achieve a centering of the axis of the cleaning device with respect to the rotor axis. In order to hold the spinning rotor during the cleaning operation, additional brake elements can be arranged on the cleaning head, which also engage on the outer circumference of the spinning rotor. Due, for example, to an angular offset between the cleaning head and the spinning rotor, an insufficient alignment of the cleaning head with respect to the spinning rotor can still occur, however, which can result in an insufficient cleaning. As a result, it may also happen, for example, that only one of the brake elements actually rests against the spinning rotor, or the brake elements act in a non-uniform manner, and so the spinning rotor is not sufficiently held during the cleaning.

The object of the present invention is therefore that of improving the brake device of the cleaning head.

The problem is solved by a cleaning device having the features of claim 1.

A cleaning device for cleaning a rotor plate of a spinning rotor comprises a receptacle, a cleaning head mounted on the receptacle, which can be advanced toward the spinning rotor for cleaning and which includes at least one cleaning element, and comprising a brake device for decelerating and/or holding the spinning rotor once the cleaning head has been advanced. The cleaning head includes an at least partially cylindrical receiving area for the spinning rotor. An axial direction and a radial direction of the cleaning head are defined by the receiving area.

It is provided that the brake device contains multiple, in particular two, brake elements, which are mounted on the cleaning head in such a way that they are movable from a neutral position into a braking position, and each of the multiple brake elements is movable with the aid of its own drive. Due to the fact that the brake elements are designed, with the aid of the drives, as active brake elements, and each brake element is driven with the aid of its own separate drive, the individual brake elements can be consistently correctly advanced toward the spinning rotor. Due to the separate drives, each of the brake elements can be reliably brought to rest against the spinning rotor, even when the cleaning head has a lateral offset or an angular offset with respect to the spinning rotor or even when the brake elements, in their neutral position, are positioned differently with respect to the spinning rotor. As a result, a uniform braking force can be consistently applied onto the spinning rotor and the spinning rotor can be reliably held during the cleaning.

According to a refinement of the invention, it is advantageous when the drives of the multiple brake elements are jointly actuatable. As a result, it can be ensured that the multiple brake elements are moved out of the neutral position into the braking position at the same time and, therefore, are caused to act upon the spinning rotor at the same time. For example, a common control signal can be fed to the drives in order to actuate the drives and, therefore, the synchronous operation can be ensured.

Moreover, it is advantageous when the drives of the brake elements are designed as pneumatic cylinders. Compressed air is generally available anyway at such a cleaning device or at a maintenance device in which such a cleaning device is arranged, and so, as a result, a cost-effective drive of the brake elements and a rapid response can be implemented.

It is likewise advantageous when the pneumatic cylinders are connected to a common compressed air source and/or to a common control valve.

If the pneumatic cylinders are connected to a common control valve, the time-synchronous operation of the multiple pneumatic cylinders and, therefore, the simultaneous advancement of the multiple brake elements can be ensured, as described above. It would also be conceivable, of course, to connect each of the pneumatic cylinders to its own control valve, but to activate the two control valves with the aid of a common actuating signal.

If the pneumatic cylinders are also still connected to a common compressed air source, the pneumatic cylinders also apply identical forces onto the spinning rotor, due to the identical operating pressure. Therefore, due to the action of the brake levers, a non-uniform braking effect cannot occur, and so a slippage of the spinning rotor can be avoided. With respect to this embodiment, it is also advantageous that this embodiment can assist in the centering of the cleaning head with respect to the spinning rotor. The cleaning head usually rests against a specific, stepped centering surface of the rotor housing during its advancement toward the spinning station. If a centering of the cleaning head with respect to the spinning rotor is nevertheless insufficient, this can be compensated for with the aid of the separately and actively drivable brake elements. If the cleaning head is also mounted on the cleaning device in such a way that it has limited movement and, after having been advanced toward the spinning station and centered on the centering surface, still allows a certain alignment movement with respect to the spinning rotor or still has a certain amount of play with respect to the spinning rotor, a fine positioning of the cleaning head can still take place via the advancing of the brake elements.

It is particularly advantageous when the brake elements are movably arranged on the cleaning device in such a way that they can be advanced toward an outer circumference of the spinning rotor with the aid of their drives. As a result, the brake device is independent of a size of the spinning rotor, since, in the case of spinning rotors of different sizes, the brake elements merely need to cover different distances between their neutral position and their braking position. In principle, it would also be possible, however, to advance the brake elements, for example, toward the open edge of the spinning rotor.

It is also advantageous when the brake elements are arranged on the cleaning device in such a way that they are movable in the radial direction of the cleaning head. Due to the fact that the brake elements engage on the slanted outer surfaces of the spinning rotor in the radial direction, a correct alignment of the cleaning head can be achieved in an easy way even in the case of an angular offset of the cleaning head with respect to the spinning rotor. It would also be conceivable, however, to displace the brake elements from their neutral position into the braking position in the axial direction of the cleaning head.

According to an advantageous refinement of the brake device, the brake elements are designed as brake levers. As a result, the displacement of the brake elements from the neutral position into the braking position with the aid of a pneumatic cylinder is possible in a particularly easy way. In addition, due to the lever action, a sufficient braking force can be ensured in an easy way. Alternatively, the brake elements could also be designed as brake shoes arranged on the cleaning head in such a way that they are displaceable in the radial direction.

If the brake elements are designed as brake levers, the brake levers are preferably rotatably mounted on the cleaning head. It would also be possible, however, to mount the brake elements on a receptacle for the cleaning head, which is connected to the cleaning head.

In order to allow for a simple alignment of the cleaning head with respect to the spinning rotor with the aid of the brake elements, it is advantageous when the cleaning head is mounted on the receptacle with the aid of one or more elastic bearing elements. As a result, the cleaning head can compensate for a radial offset and, if necessary, an angular offset with respect to the spinning rotor. Such a compensation can advantageously take place during the advancing of the cleaning head via the alignment of the cleaning head on a centering surface of the rotor housing.

Rubber buffers, for example, are conceivable as elastic bearing elements, which permit an alignment of the cleaning head in the radial direction as well as relative to an angle with respect to the axis of the spinning rotor. A mounting of the cleaning head on the receptacle with the aid of spring elements, such as spiral springs, would also be conceivable. Moreover, it would also be conceivable to connect the receptacle connected to the cleaning head, rather than the cleaning head itself, to a feed unit with the aid of elastic bearing elements.

Moreover, it is advantageous when the cleaning device comprises a feed unit on which the receptacle, including the cleaning head, is arranged. As a result, the cleaning head can be arranged in a fully automatic maintenance unit which is displaceable along the spinning machine and can be advanced toward a spinning rotor in order to clean the spinning rotor. The cleaning head is accommodated within the maintenance unit during the displacement of the maintenance unit.

It is advantageous in this case when the feed unit contains at least two linear units connected one behind the other in series. As a result, the cleaning device comprising the feed unit can be accommodated in a displaceable maintenance unit in a space-saving manner on the one hand and, on the other hand, can also implement comparatively great feed travel distances. In order to design the feed unit to be particularly space-saving, it is possible to functionally connect the two linear units one behind the other in series, but to arrange them spatially in parallel next to one another or one above the other.

According to an advantageous refinement of the feed unit, the linear units comprise different linear drives, in particular different pneumatic cylinders.

The different linear drives can have, for example, different linear travel. As a result, for example, there are various possibilities for arranging the cleaning device in the mobile maintenance unit. It is also conceivable to utilize a cleaning device for different spinning machines. In this case, for example, a first linear unit having long linear travel can implement the main feed movement and a second linear unit having short linear travel can implement adaptations of the feed travel to different spinning machines.

Alternatively or additionally, the linear units can also have a different actuating force and can comprise pneumatic cylinders having a different actuating force. For example, it is possible to implement the main feed travel with the aid of a first, large pneumatic cylinder and to limit the contact pressure of the cleaning device on the spin box (the rotor housing) or the spinning rotor with the aid of a second, smaller pneumatic cylinder. For this purpose, the two linear units or the two pneumatic cylinders are displaced one after the other with respect to time.

According to another refinement of the cleaning device, it is advantageous when the cleaning head, in particular the cleaning head including the receptacle, is pivotably arranged on the feed unit, in particular on one of the linear units. The replacement of the cleaning elements on the cleaning head or any other maintenance work on the cleaning device is facilitated as a result.

Therefore, it is also particularly advantageous when the cleaning head is pivotable from an operating position folded away from the linear unit into a maintenance position folded onto the linear unit. As a result, it is possible, for example, to carry out maintenance work on the cleaning device, in particular on the cleaning head, even when the displaceable maintenance unit, including the cleaning device, has been placed at the spinning machine and in front of a workstation.

It is also advantageous in this case when the cleaning head is lockable in the operating position. An inadvertent folding-back of the cleaning head during the advancement toward the spinning machine or during the displacement of the maintenance unit can be avoided as a result. In this connection, it is particularly advantageous when a locking device is provided on the cleaning device, which is automatically lockable when the cleaning head is transferred into the operating position. The operational reliability of the cleaning device is enhanced as a result, since the locking cannot be overlooked.

It is advantageous when the maintenance position is offset with respect to the operating position by at least 45°, preferably at least 60°, and particularly preferably at least 90°. If the cleaning device is arranged in a displaceable maintenance unit, the cleaning head is also accessible from a side of the maintenance unit facing away from the spinning machine after the cleaning head has been brought into the maintenance position.

It is also advantageous when the maintenance position is offset with respect to the operating position by a pivot angle of more than 180°. The cleaning head can therefore be pivoted into a lower position, which faces the operating personnel, in particular when the cleaning device is arranged on a high machine or is arranged at a comparatively high position in the displaceable maintenance unit. The maintenance of the cleaning head is simplified as a result.

Moreover, it is advantageous when the cleaning head comprises at least two linearly extendable scrapers, as cleaning elements. These scrapers can be accommodated in the cleaning head in a particularly simple and space-saving manner. Of course, the scrapers can also be designed as pivotable scrapers, however, and other cleaning elements, such as blow bores, brushes, and the like, can be additionally or alternatively provided, of course.

Further advantages of the invention are described in the following exemplary embodiments. In the drawings:

FIG. 1 shows a schematic, cut side view of a cleaning device and a spinning rotor, wherein the cleaning head of the cleaning device is being advanced toward the spinning rotor,

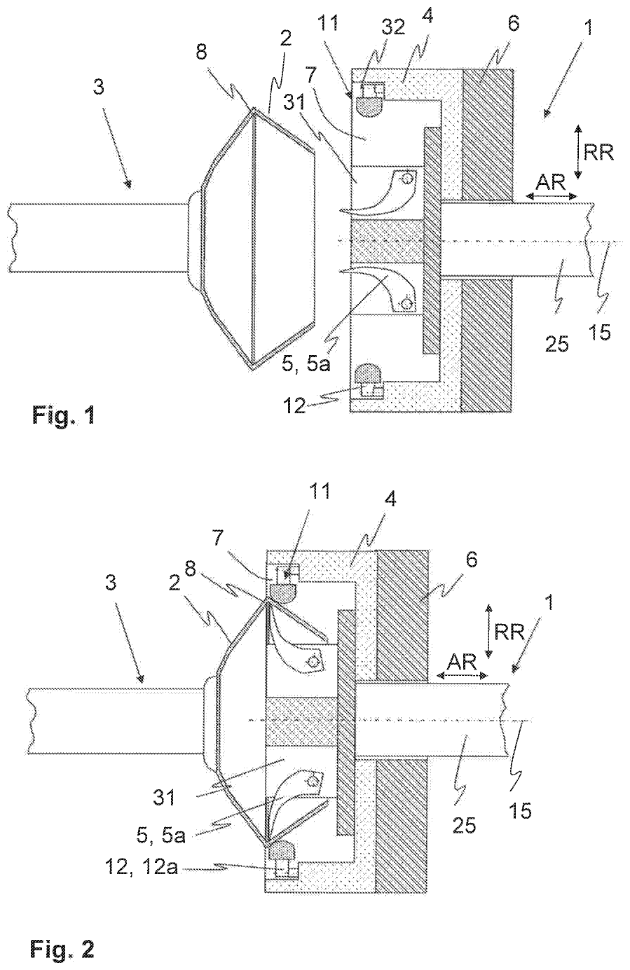

FIG. 2 shows a schematic, cut side view of the cleaning device from FIG. 1, wherein the cleaning head has been advanced to the spinning rotor,

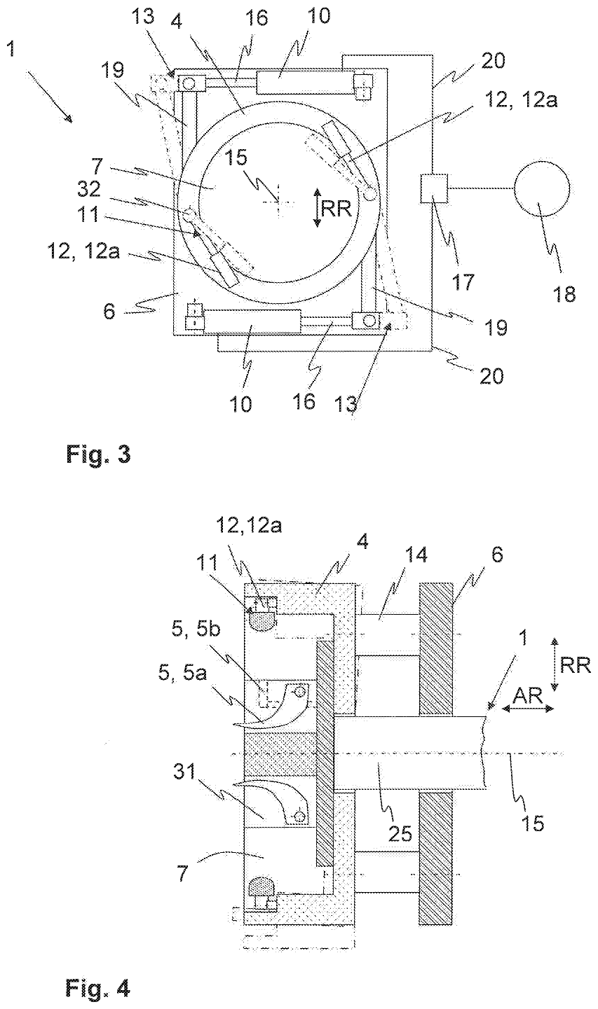

FIG. 3 shows a front view of a cleaning device comprising a cleaning head,

FIG. 4 shows a schematic, cut side view of a cleaning device according to a further embodiment,

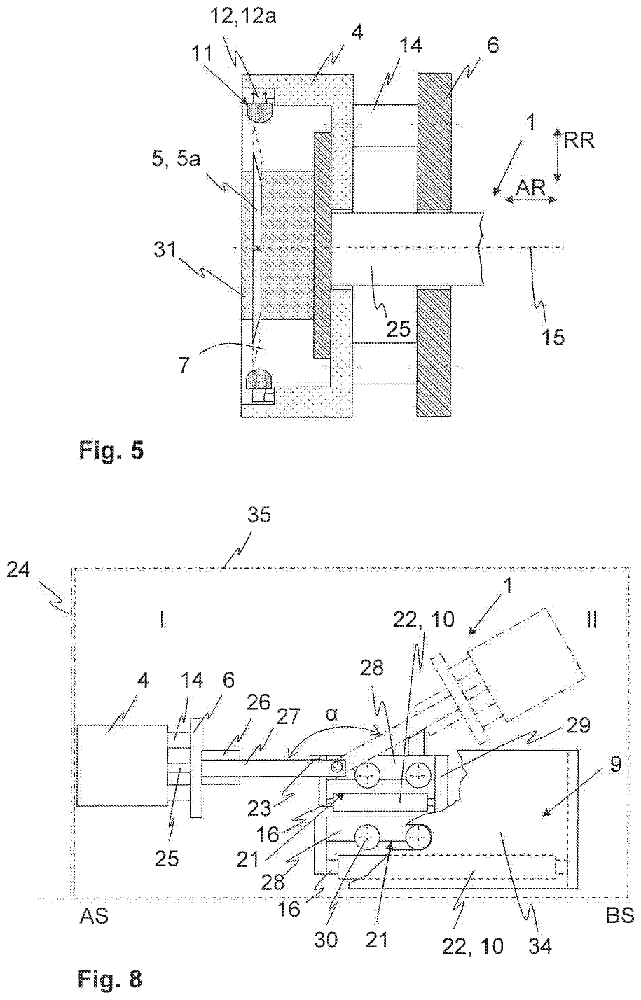

FIG. 5 shows a schematic, cut side view of a further embodiment of a cleaning device comprising a cleaning head,

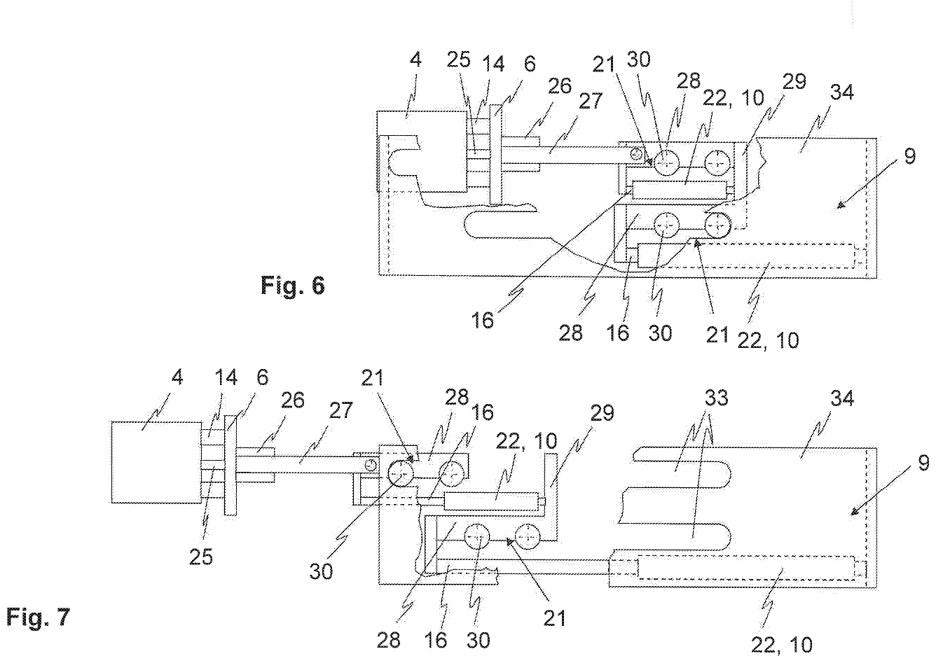

FIG. 6 shows a side view of a cleaning device comprising a cleaning head and a feed unit in a retracted position,

FIG. 7 the cleaning device from FIG. 7 in a side view and in an advanced position, and

FIG. 8 shows a side view of a cleaning device comprising a cleaning head, which can be pivoted from an operating position into a maintenance position.

In the following description of the figures, the same reference signs are utilized for features that are identical or at least comparable in the various exemplary embodiments in terms of their configuration or mode of operation. If the features are not explained again in detail with respect to a figure, their configuration and/or mode of operation correspond/corresponds to the configuration and mode of operation of the features already described above with respect to another figure. In addition, for the sake of clarity, only one of multiple identical features or components within a figure is often explained and labeled in the figures.

FIG. 1 shows a schematic, cut side view of a cleaning device 1 for cleaning a rotor plate 2 of a spinning rotor 3. The spinning rotor 3 is installed, as usual, in a spin box of an open-end spinning machine (the spin box and the spinning machine are not represented here; the spinning machine 24 is schematically represented only in FIG. 8) and is utilized for spinning a fiber material into a thread. For this purpose, fibers are introduced into a rotor plate 2 of the spinning rotor 3, are deposited in a rotor groove 8 of the spinning rotor 3, and are incorporated into the end of a thread, which has already been produced. Various impurities accumulate in the spinning rotor 3 and, in particular, in the rotor groove 8 during the course of the operation, which must be removed from time to time, since these impurities can otherwise result in malfunctions in the spinning operation.

A cleaning device 1 is therefore provided for cleaning the spinning rotor 3, which is usually arranged in a maintenance unit 35 (FIG. 8), which is not represented here and is displaceable along the spinning machine. The cleaning device 1 comprises a receptacle 6, on which a cleaning head 4 is arranged in a way known per se. At least one cleaning element 5 is arranged on the cleaning head 4, which can clean the interior space of the spinning rotor 3 and, in particular, the rotor groove 8. In this case, two scrapers 5a, as cleaning elements 5, are pivotably arranged on the cleaning head 4. The cleaning head 4 comprises an at least partially cylindrical receiving area 7 in which the cleaning head 4 can accommodate the rotor plate 2 of the spinning rotor 3 for the purpose of cleaning. The cylindrical receiving area 7 simultaneously defines, via its axis 15 (longitudinal axis of the cylindrical receiving area 7), an axial direction AR of the cleaning head 4 as well as a radial direction RR of the cleaning head 4, which is oriented perpendicularly to the axis 15 and, therefore, perpendicularly to the axial direction AR. The at least one cleaning element 5, specifically the two scrapers 5a in this case, are arranged on a carrier element 31 in a manner known per se, which is connected to an electric motor 26 via a drive shaft 25. The electric motor 26 is represented only in FIGS. 5 to 8. The carrier element 31 comprising the cleaning elements 5 can therefore be set into rotation in order to clean the spinning rotor 3.

In order to hold the spinning rotor 3 during the cleaning operation and to prevent the spinning rotor 3 from co-rotating, the cleaning head 4 also comprises a brake device 11. The brake device 11 comprises multiple—two, in this case—brake elements 12. In this case, the brake elements 12 are designed in such a way that they can be advanced toward an outer side or an outer circumference of the spinning rotor 3 or of the rotor plate 2. The brake elements 12 are arranged in the interior of the cleaning head 4 in this case.

FIG. 2 shows the cleaning head 4 and the cleaning device 1 from FIG. 1, after the cleaning head 4 has been advanced to the spinning rotor 3. The rotor plate 2 of the spinning rotor 3 is now accommodated in the receiving area 7 of the cleaning head 4. The brake elements 12 were actuated during or also after the introduction of the rotor plate 2 into the receiving area 7 and, as a result, were brought out of their neutral position represented in FIG. 1 into the braking position represented in FIG. 2. In the neutral position, the brake elements 12 are arranged close to a wall or a base of the cleaning head 4 in order to allow for the problem-free introduction of the rotor plate 2 into the receiving area 7. In the braking position, however, the brake elements 12 have been advanced to the spinning rotor 3, in particular to an outer wall of the rotor plate 2 as represented here, and are therefore capable of applying braking forces onto the rotor plate 2. The brake elements 12 are designed as brake levers 12a in this case. Moreover, after the advancement of the cleaning head 4 toward the spinning rotor 3, the cleaning elements 5, specifically the scrapers 5a in this case, were pivoted, so that they now extend into the rotor groove 8. Therefore, the cleaning elements 5 can clean the rotor groove 8 as soon as the carrier element 31 is set into rotation with the aid of the electric motor 26 (see FIGS. 5 to 8).

FIG. 3 now shows the cleaning device 1 in a front view, which is a view directly onto the receiving area 7. It is apparent that the brake elements 12, which are also designed as brake levers 12a in this case, are pivotable from their neutral position, which is represented with the aid of solid lines, into a braking position represented with the aid of dash-dotted lines. In this case, the brake levers 12a are therefore arranged on the cleaning device 1 in such a way that they are movable in the radial direction RR of the cleaning head 4. For this purpose, the brake levers 12a are mounted on the cleaning head 4 in such a way that they are rotatable about a rotational axis 32.

A separate drive 13 is provided, in each case, for moving the brake elements 12, specifically the brake levers 12a in this case. The drives 13 each contain a pneumatic cylinder 10 in this case, the piston rod 16 of which is connected to the particular assigned brake lever 12a via a pivot lever 19. In this case, the pivot lever 19 engages directly on the rotational axis 32 of the brake lever 12a. Of course, it would also be conceivable, however, to provide an electric motor in each case, as the drives 13. Since each of the brake elements 12 comprises a separate drive 13, the brake elements 12 can each be moved individually out of the neutral position into the braking position and, as a result, can be reliably brought to rest against the spinning rotor 3 even under unfavorable conditions, such as an offset between the spinning rotor 3 and the cleaning head 4.

The brake elements 12 are each connected to a common control valve 17 via a pneumatic line 20 and are also supplied by a common compressed air source 18. With the aid of the common control valve 17, a time-synchronous, joint actuation of the pneumatic cylinders 10 and the brake elements 12 can be ensured. Moreover, the same operating pressure can be fed to each of the pneumatic cylinders 10 with the aid of the common control valve 17 and/or the common compressed air source 18. As a result, the brake levers 12a or the brake elements 12 apply precisely the same braking force onto the spinning rotor 3, so that the spinning rotor 3 can be consistently reliably held during the cleaning operation.

The described cleaning head 4 comprising the separately drivable brake elements 12 can be utilized, in a particularly advantageous way, in connection with a cleaning head 4, which is mounted in such a way that it has limited movement, in order to align the cleaning head 4 relative to the spinning rotor 3.

FIG. 4 shows such a cleaning device 1, in which the cleaning head 4 is mounted in such a way that it has limited movement. For this purpose, the cleaning head 4 is mounted on the receptacle 6 in this case with the aid of multiple elastic bearing elements 14, which are designed as rubber buffers. The cleaning head 4 is therefore movable in the radial direction RR with respect to the receptacle 6, as indicated with the aid of the dash-double dotted line. As a result, the cleaning head 4 can also be tilted slightly with respect to the receptacle 6, as indicated by the dash-dotted line. The cleaning head 4 can therefore align itself automatically with respect to the spinning rotor 3, due to its limited mobility, when the cleaning head 4 comes to rest against a centering surface of the rotor housing (not represented), which is correctly positioned with respect to the spinning rotor 3. If an insufficient centering or an angular offset of the cleaning head 4 with respect to the spinning rotor 3 nevertheless occurs, it is ensured with the aid of the multiple, actively actuatable brake elements 12 that the brake elements 12 each engage on the spinning rotor 3 with the same braking force. The brake elements 12 can therefore compensate for a deviation of position that may remain after the centering, or can even carry out a fine positioning of the cleaning head 4 with respect to the spinning rotor 3.

Moreover, a blow bore 5b is indicated in FIG. 4, by way of example, as an additional cleaning element 5. The blow bore 5b can be actuated, for example, during the introduction of the rotor plate 2 into the receiving area 7, in order to clean off the open edge as well as the slide wall of the spinning rotor 3. It is understood that the representation of the cleaning elements 5 in FIG. 4 as well as in the other figures is to be understood merely as an example. In each of the embodiments shown, not only scrapers 5a, but also other cleaning elements 5 can be provided in addition to or instead of the scrapers 5a.

Moreover, modifications with respect to the scrapers 5a are also possible. For example, FIG. 5 shows a cleaning head 4, in which the scrapers 5a are not arranged on the carrier element 31 in a pivotable manner, but rather in a linearly movable manner. Of course, not only two, but also multiple scrapers 5a can be arranged in each of the embodiments.

Finally, FIGS. 6 and 7 show another cleaning device 1, in which the cleaning head 4 can be advanced toward the spinning rotor 3 with the aid of a feed unit 9. For this purpose, the receptacle 6 comprising the cleaning head 4 is arranged on the feed unit 9 with the aid of a holding arm 27. The feed unit 9 comprises two linear units 21 arranged one behind the other. Each of the linear units 21 comprises a linear drive 22, which is designed as a pneumatic cylinder 10 in this case, a displaceable carriage 28, as well as a guide 33 on which the carriages 28 are guided in each case. The guides 33 are designed in the shape of a slot in a basic body 34 of the feed unit 9 in this case, wherein the carriages 28 are displaceable in the guides 33 with the aid of rollers 30.

The linear drives 22, specifically the pneumatic cylinders 10 of the linear units 21 in this case, are differently designed in this case. The first, specifically the lower, in this case, carriage 28 of the two carriages 28 is driven with the aid of a larger pneumatic cylinder 10 represented at the bottom in the figure, which has longer linear travel and, due to its size, also has a greater actuating force. The pneumatic cylinder 10 is directly attached to the basic body 34 of the feed unit 9 and, via its piston rod 16, actuates the lower carriage 28. The lower carriage 28 comprises a connecting element 29, with the aid of which it is connected to the second linear unit 21, which is represented at the top in the figure. For this purpose, the pneumatic cylinder 10 of the upper linear unit 21 is attached to the connecting element 29 and, via its piston rod 16, now actuates the carriage 28 of the upper linear unit 21. The pneumatic cylinder 10 of the upper linear unit 21 is designed to be smaller than the lower or the first pneumatic cylinder 10 and therefore has shorter linear travel and a lower actuating force.

FIG. 6 shows the feed unit 9 in a retracted position in which it is arranged, for example, in the maintenance device when not in use. The piston rods 16 of the pneumatic cylinders 10 are retracted and the two carriages 28 are located at the beginning of their particular range of movement, specifically on the right in the figure in this case. The two carriages 28 essentially lie one above the other in this case.

If the first pneumatic cylinder 10, which is represented at the bottom of the figure in this case, is now extended, the first carriage 28, specifically the lower carriage 28 in this case, moves up to the end of its range of movement, specifically on the left in the figure in this case. The carriage 28 of the second linear unit 21 is also carried along in this case via the connecting element 29 to which the second linear unit 21 is attached. After the first carriage 28 has reached the end of its range of movement, possibly even during the displacement of the first carriage 28, the second pneumatic cylinder 10 is actuated, so that the second carriage 28 is now displaced even further, up to the end of its range of movement. This situation, in which both pneumatic cylinders 10 are fully extended, is represented in FIG. 7.

Due to the utilization of two different linear drives 22, specifically two different pneumatic cylinders 10 in this case, a long feed movement can be brought about with the aid of a large pneumatic cylinder 10 and, moreover, the contact pressure of the cleaning head 4 onto the rotor housing, against which the cleaning head rests, can be limited with the aid of a small pneumatic cylinder 10. An adaptation to different feed travel distances of different machines can also take place with the aid of the small pneumatic cylinder 10. It is particularly advantageous that standard components can be utilized and highly diverse feed travel distances and contact pressures can nevertheless be implemented.

FIG. 8 shows another embodiment of a cleaning device 1, in which the cleaning head 4 is pivotably mounted on the feed unit 9. For this purpose, the cleaning head 4 including the receptacle 6 is pivotably arranged, via the holding arm 27, on the carriage 28 of the second linear unit 21. As a result, the cleaning head 4 is pivotable from the operating position I represented with the aid of solid lines, in which the cleaning head 4 has been folded away from the feed unit 9, specifically the upper linear unit 21 in this case, into a maintenance position II represented with the aid of dash-double dotted lines, in which the cleaning head 4 has been folded onto the feed unit 9, specifically the upper linear unit 21 in this case.

As is apparent from FIG. 8, the cleaning device 1 is arranged in a displaceable maintenance unit 35 in such a way that the cleaning head 4 faces the spinning machine 24 and, therefore, is located on an operating side AS of the maintenance unit 35. As a result, the cleaning head 4 can be advanced toward the individual spinning stations of the spinning machine 24. However, the cleaning head 4 is therefore not accessible by a user for maintenance work, such as the replacement of the cleaning elements 5 or of the cleaning head 4 itself. Due to the pivoting of the cleaning head 4 into the maintenance position II, the cleaning head 4 is now accessible from an access side BS of the maintenance unit 35. The pivot angle α between the operating position I and the maintenance position II is preferably at least 90°, particularly preferably more than 120°, as represented here, in order to ensure good accessibility of the cleaning head 4 from the access side BS. Moreover, a locking element 23 is also provided in this case, which fixes the cleaning head 4 in the operating position I. For this purpose, the locking element 23 blocks the holding arm 27 in the operating position I.

Depending on the arrangement of the cleaning device 1 in the maintenance unit 35 and of the cleaning head 4 on the cleaning device 1, a pivot angle α between the operating position I and the maintenance position II of more than 180° can also be meaningful, however. As a result, the receiving area 7 of the cleaning head 4 is directly slightly downward in the maintenance position II, whereby its accessibility for the operating personnel is improved.

The present invention is not limited to the represented and described exemplary embodiments. Modifications within the scope of the claims are also possible, as is any combination of the features, even if they are represented and described in different exemplary embodiments.

### LIST OF REFERENCE SIGNS

1 cleaning device
2 rotor plate
3 spinning rotor
4 cleaning head
5 cleaning element
5a scraper
5b blow bore
6 receptacle
7 receiving area
8 rotor groove
9 feed unit
10 pneumatic cylinder
11 brake device
12 brake element
12a brake lever
13 drive
14 bearing element
15 axis
16 piston rod
17 control valve
18 compressed air source
19 pivot lever
20 pneumatic line
21 linear unit
22 linear drive
23 locking element
24 spinning machine
25 drive shaft
26 electric motor
27 holding arm
28 carriage
29 connecting element
30 roller
31 carrier element
32 rotational axis
33 guide
34 basic body
35 maintenance unit
AR axial direction
RR radial direction
I operating position
II maintenance position
α pivot angle
AS operating side
BS access side

1. A cleaning device (1) for cleaning a rotor plate (2) of a spinning rotor (3), comprising a receptacle (6), a cleaning head (4) mounted on the receptacle (6), which can be advanced toward the spinning rotor (3) for cleaning and which includes at least one cleaning element (5, 5a, 5b), and comprising a brake device (11) for decelerating and/or holding the spinning rotor (3) once the cleaning head (4) has been advanced, wherein the cleaning head (4) comprises an at least partially cylindrical receiving area (7) for the spinning rotor (3), which defines an axial direction (AR) and a radial direction (RR) of the cleaning head (4), characterized in that the brake device (11) contains multiple, in particular two, brake elements (12), which are mounted on the cleaning head (4) in such a way that they are movable from a neutral position into a braking position, and each of the multiple brake elements (12) is movable with the aid of its own drive (13).

2-18. (canceled)
